(19) United States
(12) Patent Application Publication
(10) Pub. No.: US 2006/0050620 A1
(43) Pub. Date: Mar. 9, 2006

(54) Optical scanning device

(75) Inventor: Johannes Hendrikus Maria Spruit, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONONKLIJKE PHILPS ELECTRONICS N.V., Eindhoven (NL)

(21) Appl. No.: 10/517,482

(22) PCT Filed: Jun. 5, 2003
(86) PCT No.: PCT/IB03/02411

§ 371 Date: Dec. 7, 2004

(30) Foreign Application Priority Data
Jun. 12, 2002 (EP) 02077295.0

(51) Int. Cl. G11B 7/00

(52) U.S. Cl. 369/125

(57) ABSTRACT

A method of scanning an optical recording medium having data storage regions arranged in generally concentrically arrange track sections therein, the method comprising rotating the optical recording medium such that the disk moves in a spinning direction (S) with respect to a scanning spot, and maintaining tracking in a radial sense using a push-pull radial error signal generated by detecting push-pull signals from at least three radiation spots formed on the disk, a main spot (c), a forward spot (a) and a rear spot (b), to move the spots in a radial scanning direction (R) during a plurality of rotations of the disk, wherein the forward spot scans the optical recording medium in a position which is tangentially offset from the main spot in a direction opposite to the spinning direction, and the rear spot scans the optical recording medium in a position which is tangentially offset from the main spot in a direction coinciding with the spinning direction, characterized in that the method comprises positioning the three radiation spots with radial offsets such that the forward spot is located in a position which is radically offset from the main spot in a direction coinciding with the radial scanning direction, and such that the rear spot is located in a position which is radically offset from the main spot in a direction opposite to that of the radial scanning direction.

This invention relates to an optical unit for use in optical scanning devices for scanning an optical recording medium, such as an optical disk, including at least one information layer, in particular to such a unit which is capable of recording data onto optical recording media, and to an optical scanning device including such a unit.

Known radial tracking error detection methods include push-pull radial tracking, in which a difference in signal between two pupil halves are measured on separate detectors; central aperture radial tracking, in which the radiation beam is split into three by a diffraction grating, and the outer (satellite) spots are set a quarter track pitch off the main spot and the difference of their signals used to generate the tracking error signal; three spots push-pull radial tracking, in which the radiation beam is split into three by a diffraction grating and a difference between the push-pull signals of the main spot and the satellite spots is used as the tracking error signal; and Differential Phase or Time Detection (DPD or DTD) radial tracking, in which the radial tracking offset is detected by monitoring the phase of the (±1,±1) order beams using a square-shaped quadrant spot detector. The three spot push-pull radial tracking system has an advantage over one spot push-pull systems in that systematic errors, including symmetric errors and asymmetric errors, may be compensated for automatically. The three spot push-pull radial tracking system has an advantage over central aperture radial tracking in a recording device in that a significantly higher signal-to-noise ratio is achieved, in particular when scanning a blank optical disk.

In accordance with one aspect of the present invention there is provided a method of scanning an optical recording medium in the form of a disk having data storage regions arranged in generally tangentially arranged track sections therein, the method comprising rotating the optical recording medium such that the disk moves in a spinning direction with respect to a scanning spot, and maintaining tracking in a radial sense using a push-pull radial error signal generated by detecting push-pull signals from at least three radiation spots formed on the disk; a main spot, a forward spot and a rear spot, to move the spots in a radial scanning direction across adjacent track sections during a plurality of rotations of the disk, wherein the forward spot scans the optical recording medium in a position which is tangentially offset from the main spot in a direction opposite to the spinning direction, and the rear spot scans the optical recording medium in a position which is tangentially offset from the main spot in a direction coinciding with the spinning direction, characterized in that the method comprises positioning the three radiation spots with radial offsets such that the forward spot is located in a position which is radially offset from the main spot in a direction coinciding with the radial scanning direction, and such that the rear spot is located in a position which is radially offset from the main spot in a direction opposite to that of the radial scanning direction.

By use of the present invention, significantly more accurate tracking, in particular during a first write process, can be achieved compared to the conventional three spots push-pull radial tracking, in which the satellite spots are positioned in a formation which is mirrored, about the track direction, with respect to their alignment in the present invention.

It is noted that Japanese patent applications JP 5-12700 and JP 5-135382 generate satellite spots which are oppositely positioned on opposite sides of a track being scanned on an optical disk in order to prevent offsets in the tracking error signal at the border between a recorded section and an unrecorded section of a disk. However, the solution proposed is in relation to multiple-spot central aperture radial tracking error detection. In the case of a multi-spot central aperture radial tracking error detection system the satellite spots are placed with a radial spacing of ¼ of the track pitch from the main spot. This results at the transition of a written and non-written area in a satellite spot experiencing high reflectivity and a satellite spot experiencing low reflectivity. The resulting tracking offsets in this system can be cancelled by using four satellite spots as described in these prior patent applications. However, using two satellite spots, as per the preferred embodiment of the present invention, irrespective of their alignment, will not solve the problem of radial offsets in central aperture radial tracking error detection. Moreover, in a push-pull radial tracking error detection the tracking offsets will not be reduced in the same way by the use of four satellite spots as described in these prior patent applications.

In accordance with a second aspect of the invention, there is provided an optical scanning device arranged to carry out the method of the invention.

Further aspects and advantages of the invention will become apparent from the following description of preferred embodiments of the invention, made with reference to the accompanying drawings, wherein:

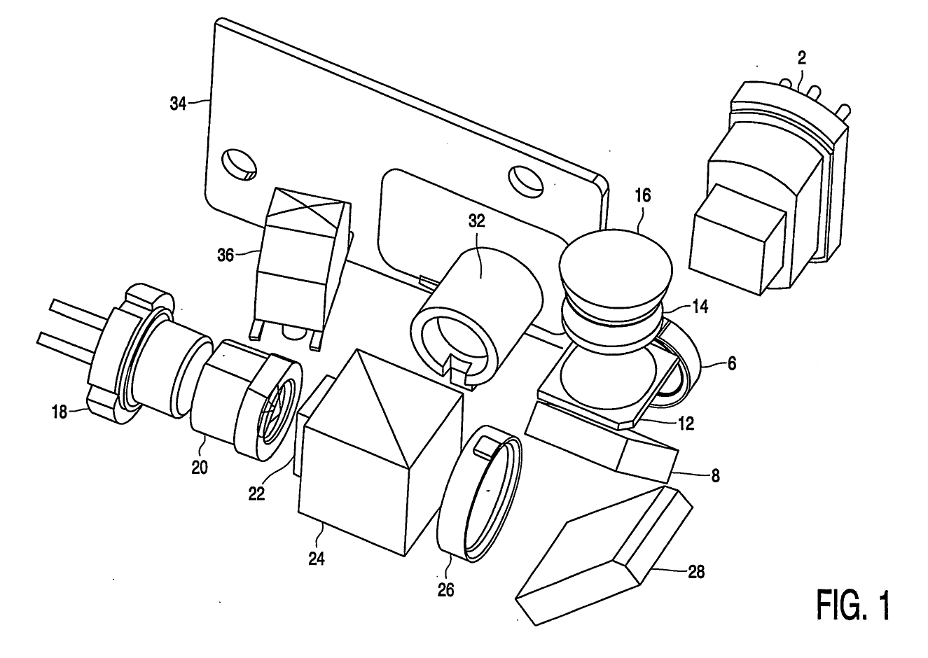

FIG. 1 shows a perspective view of an optical scanning device arranged in accordance with an embodiment of the invention;

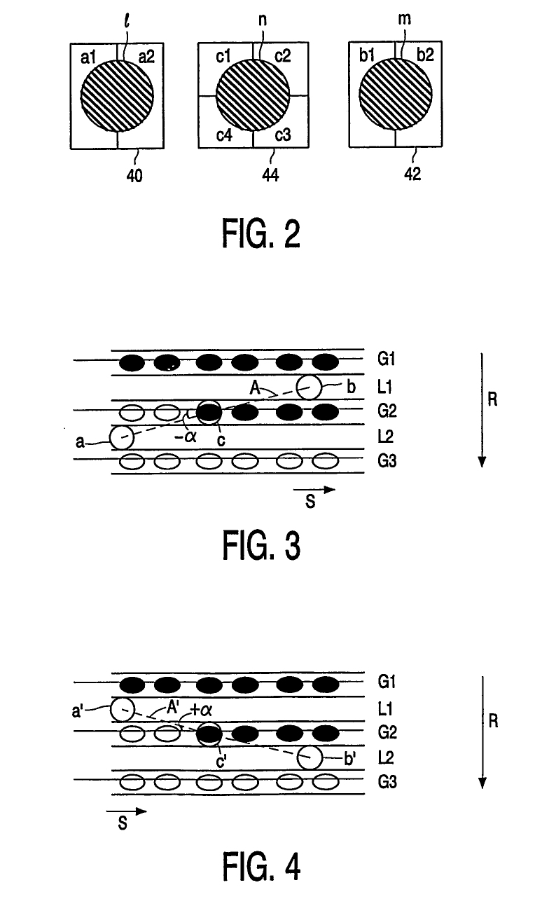

FIG. 2 is a plan view of a three spots push-pull tracking error detector array used in an embodiment of the invention;

FIG. 3 is a schematic plan view of an optical disk being scanned during a first-write process, in accordance with an embodiment of the present invention;

FIG. 4 is a schematic plan view of an optical disk being scanned during a first-write process, in accordance with the prior art;

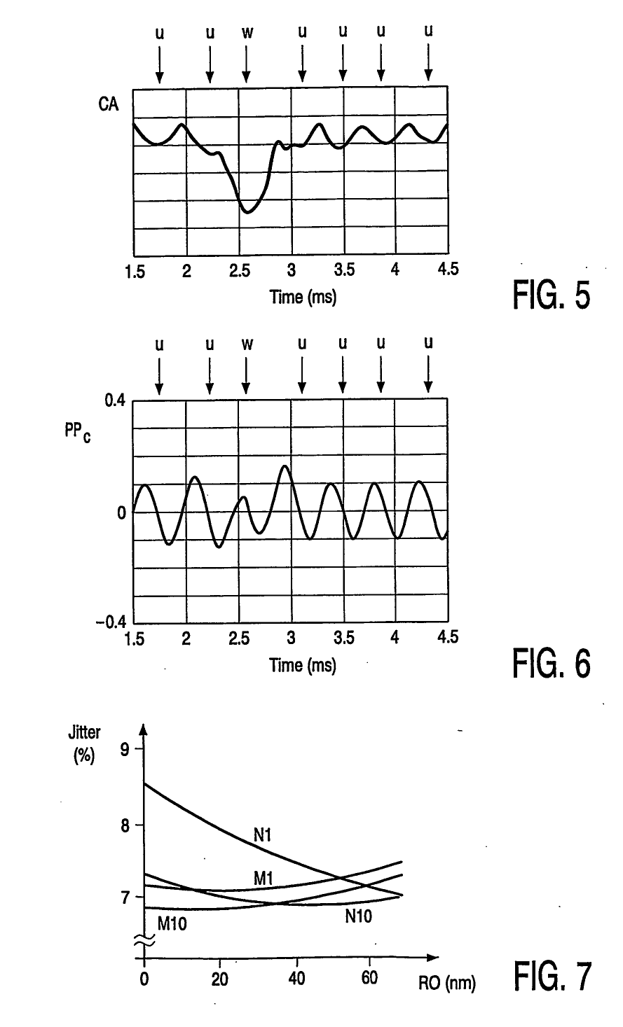

FIG. 5 is a graph showing a central aperture signal produced during a scan across a plurality of track sections;

FIG. 6 is a graph showing a push-pull signal produced during a scan corresponding to that shown in FIG. 5; and

FIG. 7 is a graph showing variations in jitter produced during read out from track sections written with data using the present invention, compared to that of the prior art.

In accordance with embodiments of the invention, a recordable and/or rewritable format of optical disk, such as the DVD+RW format is used for storing data. The disk may be written and/or read-out by means of the optical scanning device. The disk includes an outer transparent layer covering at least one information layer. In the case of a multilayer optical disk, two or more information layers are arranged behind the cover layer, at different depths within the disk. The side of the information layer, or in the case of a multilayer disk the side of the layer furthest away from the cover layer, facing away from the transparent layer is protected from environmental influences by a protection layer. The side of the transparent layer facing the device is the disk entrance face.

Information may be stored in the information layer or layers of the optical disk in the form of optically detectable marks arranged in substantially parallel, spirally arranged track sections formed as land-groove structures inside the disk.

In accordance with an embodiment of the invention, different formats of optical recording medium may be scanned. These include read-only optical disks, such as those of the CD (Compact Disk) format, which may be read-out by means of an optical pickup unit (OPU), and recordable optical disks, such as those of the DVD+RW (Digital Versatile Disk+Rewritable) format, may be written and/or read-out by means of the OPU. The optical components of the OPU are held in a rigid housing which is formed of molded aluminum or suchlike. The OPU is arranged in an optical recording and/or playback device such that the OPU travels along a linear bearing arranged radially of the disk during scanning of the disk. Each disk to be scanned is located in a planar scanning area adjacent to the OPU, mounted on a motorized rotating bearing in the playback and/or recording device, whereby the disk is moved relative to the OPU during playback and/or writing.

Each of the different formats of disk to be scanned by the device includes at least one information layer. In the case of the recordable disks, the information layer or layers are formed of an optically recordable material, for example a phase change material as used in the DVD+RW format.

The OPU in this embodiment includes two optical branches for scanning disks with radiation of two different wavelengths, in this embodiment a wavelength of approximately 780 nm (referred to herein as “the CD wavelength”) and a wavelength of approximately 650 nm (referred to herein as “the DVD wavelength”).

Reference is now made to FIG. 1. The first optical branch, which is arranged in a planar layer parallel to the optical disk scanning area, in this embodiment comprises a Laser Detector Grating Unit (LDGU) 2 which includes a polarized radiation source, for example a semiconductor laser, operating at a predetermined wavelength, in this example the CD wavelength, to produce a first beam 4; a photodiode detector array for detecting a data signal and focus and radial tracking error signals in the first beam reflected from the optical disk; and a holographic grating for splitting the beam for the focus and radial tracking error signal generation. The LDGU 2 emits a diverging radiation beam 4. The first branch further includes, arranged along a first linear optical path portion along with the LDGU, a collimator lens 6 for producing a more collimated beam, nevertheless slightly non parallel so as to compensate for spherical aberrations generated by a transparent layer in the disk, and a dichroic beam splitter 8 for folding the first beam through 90° to be directed in the axial direction of the optical disk 10 and towards the optical disk 10 and the reflected first beam towards the detector of the LDGU 2. The optical disk 10 is one designed for readout and/or writing at the CD wavelength.

In the optical path portion between the beam splitter 8 and the optical disk 10, which portion is shared by the two radiation beams of the device, lie a quarter wavelength plate 12, operative at the DVD wavelength, a dichroic aperture, operative to reflect radiation at the CD wavelength in an area outside a predetermined radial distance from the optical axis, and a dual beam objective lens 16. The dual beam objective lens may be one of a number of different types of lens, whether a compound or single lens, for correctly focusing, with limited spherical aberration, the collimated CD wavelength beam to a spot on the information layer in the disk operative at the CD wavelength, and a collimated DVD wavelength beam to a spot on an information layer in a disk operative at the DVD wavelength.

The first beam is transmitted through quarter wave plate, stopped by aperture 14 and focused by objective lens 16 to a spot on the disk 10. The reflected beam is transmitted back to the LDGU 2 in the return path, where the data, focus error and tracking error signals are detected. The objective lens 16 is driven by servo signals derived from the focus error signal to maintain the focussed state of the spot on the optical disk 10.

The second optical branch, which is arranged in a single planar layer parallel to the optical disk scanning area and spaced further from the scanning area than the first optical branch, in this embodiment includes a polarized radiation source 18, for example a semiconductor laser, operating at a predetermined wavelength different to that of the first beam, in this example the DVD wavelength, to produce a second beam 19. The optical path for the second beam includes, arranged along a second linear optical path portion along with the source 18, a beam shaper 20 for correcting ellipticity in the emitted beam, a holographic grating 22 for splitting the second beam to generate satellite spot beams for focus and radial tracking error signal generation at a detector array 34, a polarizing beam splitter 24 for reflecting the reflected second beam towards the detector array, a collimator lens 26 for substantially collimating the second beam, and a folding mirror 28 for reflecting the second beam through 90° to be directed in the axial direction of the optical disk 30 and towards the optical disk 30, which is a disk designed to operate at the DVD wavelength. The second beam is transmitted substantially fully by the dichroic mirror 8, is altered in polarization from linear to circular polarization by quarter wave plate 12, is transmitted by aperture 14 and focused to a spot on an information layer in the disk 30. The reflected beam follows a return path, being transformed back to a beam exhibiting linear polarization perpendicular to the incident beam by the quarter wave plate 12, and is reflected by beam splitter 24 along a third linear optical path portion towards detector lens 32, which focuses the reflected beam towards a photodiode detector array arranged on detector substrate 34, at which a data signal and tracking and focus error signals are detected. The objective lens 16 is driven by servo signals derived from the focus error signal to maintain the focussed state of the spot on the optical disk 10 and the detector array. The OPU further comprises a tilt sensor unit 36 for detecting tilt of the disk relative to the optical axis of the optical scanning system, and for generating a tilt error signal which may be used in correcting the readout or write characteristics of the device to compensate for different levels of detected tilt during the scanning of the disk.

In this embodiment of the present invention, three beam spots, namely spots formed by first order satellite beams and the zeroth order beam, are formed by grating 22 on the optical disk. The track sections of the disk are arranged in the radial direction as alternate groove and land sections respectively, with data being written in, or writable to, the groove track sections.

FIG. 2 shows an arrangement of three spot detectors as used in the present invention, first order satellite spot detectors 40 and 42 each including two half detector elements, a1, a2; b1, b2, and zeroth order spot detector 44 including four quadrant detector elements c1, c2, c3, c4 respectively, used for detecting a push-pull radial tracking error in the three detector spots 1, m and n and astigmatic focus error in the main detector spot n. The spot detectors 40, 42, 44 are arranged in the optical scanning device in a generally tangential equivalent (generally track-parallel) direction. Three spots push pull radial tracking uses the push pull signal, namely the difference between elements making up areas detecting approximately half of a detector spot, of all three spots.

Connections are formed in the detector array, and the signals are processed, to provide a radial error signal (RE) as follows:
RE=c1−c2−c3+c4−γ(a1−a2+b1−b2) (1)

where γ is a grating ratio. The grating ratio is a value, greater than one, chosen such that the contribution to the radial error signal from the two side detectors 40, 42 is of the same order of magnitude as that from the central detector 44. Typically, the grating ratio is given a value in the range of between 5 and 10; for example 7.

Referring now to FIG. 3, this shows an area of a disk during a first-write recording process using an optical scanning device in which diffraction grating 22 and detector elements 40, 42, 44 are aligned in accordance with an embodiment of the invention. Here, dark-filled ovals represent recorded data areas and white-filled ovals represent unrecorded areas. In the manner in which the diffraction grating is aligned in this embodiment of the invention, a main, zeroth order, disk spot c and two, first order, satellite disk spots, a forward spot a and a rear spot b are aligned along a linear axis A which is arranged at an angle (−α), typically between −5° and 0° and preferably in the region of −1°, with respect to the track-parallel (i.e. tangential on the disk) direction. The satellite spots are placed with a radial offset of ½ of the land/groove track pitch from the main spot. During scanning of the disk, whether writing data to or reading data from the disk, the disk is spun in a direction such that the part of the disk illustrated in FIG. 3 moves in the spinning direction S. Thus, the forward spot a, which is arranged with a tangential offset with respect to the main spot c which is opposite to the spinning direction S, crosses a given imaginary line perpendicular to the track sections on the disk prior to the main spot c. Conversely, the rear spot b, which is arranged with a tangential offset with respect to the main spot c which coincides with the spinning direction S, crosses a given imaginary line perpendicular to the track sections on the disk after the main spot c.

Due to the spiral arrangement of the preformed land and groove track sections, when scanning along a groove track section G2, the spots are moved in parallel in the radial scanning direction R during write operations, which typically include a plurality of rotations of the disk. In this embodiment, the radial scanning direction R corresponds to movement from an inner radial part of the disk towards an outer radial part of the disk.

When writing data to an unwritten disk, as shown in FIG. 3, written data track sections, such as groove track section G1, are located with respect to the location of the main spot c in a direction opposite to that of the radial scanning direction. Conversely, unwritten data track sections, such as groove track section G3, are located with respect to the main spot c in a direction coinciding with that of the radial scanning direction R. The forward spot a is located on an adjacent land track section L2 and is positioned, with respect to the main spot, with a radial offset in a direction coinciding with that of the radial scanning direction R. The rear spot b is located on an adjacent land track section L1 and is positioned, with respect to the main spot, with a radial offset in a direction which is opposite to the radial scanning direction R.

Alignment of the grating 22 and detector elements 40, 42, 44 to position the disk spots in this manner has been found to provide more accurate tracking in relatively high density disks, in comparison with the prior art alignment, which was originated for relatively low density disk (in particular, the CD format), in which the same push-pull radial tracking accuracy problems are not seen.

Referring now to FIG. 4, this shows an area of a disk during a first-write recording process using an optical scanning device in which diffraction grating 22 and detector elements 40, 42, 44 are aligned in accordance with the prior art. Here, dark-filled ovals represent recorded data areas and white-filled ovals represent unrecorded areas. In the manner in which the diffraction grating is aligned in the prior art, the main spot c′ and the two satellite spots, a forward spot a′ and a rear spot b′ are aligned along a linear axis A′ which is arranged at an angle (+β) with respect to the track-parallel (i.e. tangential on the disk) direction. During scanning of the disk, whether writing data to or reading data from the disk, the disk is spun in a direction such that the part of the disk illustrated in FIG. 4 moves in the spinning direction S. Due to the spiral arrangement of the preformed land and groove tracks, when scanning along a groove track section G2, the spots are moved in parallel in the radial scanning direction R. Generally, the radial scanning direction R corresponds to movement from an inner radial part of the disk towards an outer radial part of the disk. As a result, when writing data to an unwritten disk, as shown in FIG. 4, written data track sections, such as groove track section G1, are located with respect to the location of the main spot c in a direction opposite to that of the radial scanning direction. Conversely, unwritten data track sections, such as groove track section G3, are located with respect to the main spot c in a direction coinciding with that of the radial scanning direction R. The forward spot a′ is located on an adjacent land track section L1 and is positioned, with respect to the main spot, with a radial offset in a direction opposite to that of the radial scanning direction R. The rear spot b′ is located on an adjacent land track section L2 and is positioned, with respect to the main spot, with a radial offset in a direction which coincides with the radial scanning direction R.

FIG. 5 illustrates a detected central aperture signal (generated by taking the output from each of the detector elements c1, c2, c3, c4 shown in FIG. 2 and processing them as follows: c1+c2+c3+c4) when scanning across a number of data track sections on a disk using a single spot detector arrangement. In this case, a single track section was written on the disk, corresponding to section W of the graph. In this case, the optical head was maintained in a set position whilst a disk was scanned. Due to eccentricity of the data track with respect to the spinning of the disk, a number of data track sections were scanned without movement of the optical head. As can be seen, the central aperture detection signal varies in a similar manner, with relatively small degrees of variation, at each of the graph sections U corresponding to unwritten data track sections, whilst at the written data track section W, a large decrease in the central aperture signal is seen.

FIG. 6 illustrates a detected main spot push-pull signal (generated by taking the outputs of each of the detector elements c1, c2, c3, c4 shown in FIG. 2, and processing them as follows: c1−c2−c3+c4) when the scan shown in FIG. 5 was made. As can be seen, the push-pull signal also varies in a similar manner, however with relatively large degrees of variation, at each of the graph sections U corresponding to unwritten data track sections. On the other hand, at the written data track section W, a significant variation in the shape of the push-pull signal curve is seen. This illustrates that any tracking carried out using this push-pull signal could be inaccurate in particular in an area in which there is a transition between written and unrecorded sections of a disk.

FIG. 7 illustrates a variation in detected jitter when reading data from a recorded area of a disk, with different preset radial offsets. The data was written respectively using the three spot alignment in an embodiment of the present invention, and the three spot alignment in the prior art. Curve N1 shows the variation in jitter detected at various radial offsets for data written in a first-write process using the prior art alignment. As can be seen, jitter is relatively high at a zero radial offset, at which data is read out by tracking at the center of a groove track, and decreases towards a greater radial offset. This indicates that the data written into the track was written with a relatively large radial offset caused by incorrect tracking. Curve N10 shows the variation in jitter detected at various radial offsets for data written in a tenth overwrite process. As can be seen, the jitter seen at zero radial offset is lower than that seen in the first-write curve N1, and the curve is more horizontal, indicating that the data was written at a lesser tracking offset than that in the first-write case.

In comparison, the curve in jitter variation with radial offset seen in the first-write case when written using the arrangement of the present invention, curve M1, has a relatively low jitter at the zero radial offset, and increases gradually outwards, indicating that the data was written with a more accurate tracking than in the prior art case. Similarly, the curve seen for the tenth overwrite, curve M10, also indicates that the tracking was more accurate using the alignment of the present invention compared with that of the prior art.

The relatively large variation seen between the first-write curve N1 and the tenth overwrite curve N10 can be taken to be due to the fact that, in the prior art alignment, the forward spot a′ and the rear spot b′ experience an unsymmetrical environment due to having a written track to one side and an unwritten track to the other side, whereas once a recorded area is being overwritten, written track sections are symmetrically arranged about the two satellite spots. In contrast, in the arrangement in accordance with the present invention, in the first write case, both satellite spots experience a symmetrical arrangement, thus providing a more accurate tracking error signal. The forward spot a has unwritten track areas to each side, and the rear spot b has written track areas to both sides. In fact, curves M1 and M10 indicate that the tracking accuracy, whilst being improved most significantly in the case of the first-write process, can also be improved in an overwrite process using the present invention.

In a further embodiment of the invention, the detector signals are processed, to provide the radial error signal (RE) as follows:
RE=c1−c2−c3+c4−γ₁(a1−a2)−γ₂(b1−b2) (2)

where γ₁ and γ₂ are different grating ratios for the different satellite spots. Different grating ratios are introduced since the satellite spots experience different reflectivities due to their respective written and unwritten area surroundings in a first-write process. The grating ratios are selected such that the contribution of the second term (namely γ₁(a1−a2)) and the second term (namely γ₂(b1−b2)) are generally well balanced. Typically, due to the increased reflectivity of written regions, γ₁ and γ₂ are selected such that γ₁>γ₂.

A signal processing mode using equation (2) above may be selectively activated when conducting a first-write process. In one embodiment, this signal processing mode is selectively activated in response to the detection of the insertion of a write-once only type disk during a data writing process. On the other hand, a mode using equation (1) above is selectively activated in other processes, such as for data read-out and during overwrite processes.

The invention is applicable to scanning devices other than those described above, such as the DVD-RW, DVD+R, DVD-R and DVR formats, and to various combinations thereof. In general, the invention is particularly applicable to high density recording systems in which relatively small track pitches, compared to the scanning spot size in the recording medium, are used. The invention is of particular application to systems in which the track pitch (P) satisfies the following relation:
P<0.8λ/NA (3)

where λ is the wavelength of the scanning radiation and NA the numerical aperture of the beam at the optical disk.

Note that herein, the track pitch is the spacing between the centers of two adjacent groove track sections in a land/groove track structure.

The invention is applicable to both single-layer disks and multi-layer disks. In the case of a multi-layer disk, such as a dual-layer disk, it is preferred that the track sections of both information layers are arranged as spirals having the same spiral directionality, such that the improved tracking provided by the present invention is provided when scanning both layers.

The above embodiments are to be understood as illustrative examples of the invention. Further embodiments of the invention are envisaged. Whilst only three spots push-pull is preferred to maintain a high write power, more than three spots push-pull radial tracking error detection may also be used. It is to be understood that any feature described in relation to one embodiment may also be used in other of the embodiments. Furthermore, equivalents and modifications not described above may also be employed without departing from the scope of the invention, which is defined in the accompanying claims.

1. A method of scanning an optical recording medium in the form of a disk having data storage regions arranged in generally concentrically arranged track sections therein, the method comprising rotating the optical recording medium such that the disk moves in a spinning direction (S) with respect to a scanning spot, and maintaining tracking in a radial sense using a push-pull radial error signal generated by detecting push-pull signals from at least three radiation spots formed on the disk, a main spot (c), a forward spot (a) and a rear spot (b), to move the spots in a radial scanning direction (R) across adjacent track sections during a plurality of rotations of the disk, wherein the forward spot scans the optical recording medium in a position which is tangentially offset from the main spot in a direction opposite to the spinning direction, and the rear spot scans the optical recording medium in a position which is tangentially offset from the main spot in a direction coinciding with the spinning direction, characterized in that the method comprises positioning the three radiation spots with radial offsets such that the forward spot is located in a position which is radially offset from the main spot in a direction coinciding with the radial scanning direction, and such that the rear spot is located in a position which is radially offset from the main spot in a direction opposite to that of the radial scanning direction.

2. A method according to claim 1, wherein the push-pull signals are detected using three spot detectors, first order satellite spot detectors (40, 42) each including two detector elements providing respective signals a1, a2; b1, b2, and zeroth order spot detector (44) including four quadrant detector elements providing respective signals c1, c2, c3, c4.

3. A method according to claim 2, wherein a push-pull radial error signal (RE) is processed as follows:
RE=c1−c2−c3+c4−γ(a1−a2+b1−b2)
where γ is a grating ratio.

4. A method according to claim 2, wherein a push-pull radial error signal (RE) is processed as follows:
RE=c1−c2−c3+c4−γ₁(a1−a2)−γ₂(b1−b2)
where γ₁ and γ₂ are different grating ratios.

5. A method according to claim 3 or 4, wherein the processing of the radial error signal is altered in dependence on a scanning condition.

6. A method according to claim 5, wherein the processing method of claim 4 is selectively actuated during a first-write process.

7. A method according to any preceding claim, wherein said push-pull radial error signal is generated by detecting push-pull signals from only three radiation spots formed on the disk.

8. A method according to any preceding claim, wherein said optical recording medium has a single information layer.

9. A method according to any of claims 1 to 7, wherein said optical recording medium has a least two information layers.

10. A method according to claim 9, wherein each of the information layers comprise track sections arranged in spirals having the same directionality.

11. A method according to any preceding claim, wherein the track pitch (P) satisfies the following relation:
P<0.8λ/NA
where λ is the wavelength of the scanning radiation and NA is the numerical aperture of the scanning radiation.

12. A method according to any preceding claim, wherein the optical recording medium format is one selected from the group of the DVD+RW, DVD-RW, DVD+R, DVD-R, and DVR formats.

13. A method according to any preceding claim, wherein the scanning comprises a first-write process.

14. An optical scanning device arranged to carry out the method of any preceding claim.
